(19) United States
(12) Patent Application Publication
(10) Pub. No.: US 2025/0382812 A1
(43) Pub. Date: Dec. 18, 2025

(54) ACOUSTIC COMMUNICATION WITH SUBMERGED ROBOTS

(71) Applicant: Maytronics Ltd., Kibutz Yizrael (IL)

(72) Inventors: Gilad Goldenberg, Kfar saba (IL); Avshalom Kehati, Zikhron Yaakov (IL); Netanel Spector, Kibbutz Regavim (IL)

(73) Assignee: Maytronics Ltd., Kibutz Yizrael (IL)

(21) Appl. No.: 19/313,797

(22) Filed: Aug. 28, 2025

Related U.S. Application Data
(63) Continuation-in-part of application No. 18/840,470, filed on Aug. 21, 2024.
(60) Provisional application No. 63/364,112, filed on May 4, 2022.
(60) Provisional application No. 63/688,768, filed on Aug. 29, 2024.

(51) Int. Cl. E04H 4/16; B06B 1/02; B06B 1/06; B63B 79/10; B63B 79/40; G05D 1/226; G05D 105/10; G05D 107/00; G05D 109/30; H04B 11/00

(52) U.S. Cl. CPC E04H 4/1654; B06B 1/0284; B06B 1/0651; B63B 79/10; B63B 79/40; H04B 11/00; B06B 2201/74; G05D 1/226; G05D 2105/10; G05D 2107/29; G05D 2109/38

(57) ABSTRACT

The present disclosure provides a cleaning robot comprising one or more motors and a controller configured to control the one or more motors to generate acoustic signals indicative of content. The controller is configured to control at least one of a frequency of the acoustic signals and a pulse width of acoustic pulses generated by the one or more motors. The controller may be configured to control the one or more motors to generate an ascending sequence of frequencies and to use a frequency of a pulse generated by the one or more motors to validate a pulse width of the pulse. The one or more motors are configured to transmit frequency tones that indicate bits of a first value within the content. The one or more motors comprise at least one of a pump motor and a drive motor, wherein the controller is configured to control electric power within a motor coil using pulse width modulation to generate the acoustic signals.

### CROSS-REFERENCE TO RELATED APPLICATIONS

This application claims priority to U.S. provisional patent Ser. No. 63/688,768,filing date Aug. 29, 2024, which is hereby incorporated by reference in its entirety.

This application is a continuation-in-part of U.S. patent application Ser. No. 18/840,470 filing date Aug. 21, 2024, which is a national phase of PCT patent application serial number PCT/IB2023/054023 filing date Apr. 19, 2023, which claims priority from U.S. provisional patent Ser. No. 63/364,112 filing fate May 4, 2022-all being incorporated by reference in their entirety.

### FIELD OF INVENTION

The present disclosure relates to acoustic communication systems for underwater robotics, and more particularly to methods and devices for wirelessly communicating with submerged robots using unique acoustic signals that differ from environmental noise and robot-generated sounds.

### BACKGROUND

Pool cleaning robots have become increasingly popular for maintaining swimming pools, as they provide automated cleaning capabilities that reduce manual labor and maintenance time. These robotic systems typically operate by being submerged in the pool water and following programmed navigation patterns to clean pool surfaces and filter debris.

Traditional pool cleaning robots often rely on physical power and communication cables that connect the submerged robot to a control unit or power source located outside the pool. These cables enable straightforward transmission of commands and power to the robot during operation. However, the presence of cables can create various inconveniences for pool users, including potential entanglement hazards, restrictions on robot movement, and interference with swimming activities.

The desire for cordless pool cleaning robots has grown as users seek more convenient and less intrusive cleaning solutions. Cordless systems eliminate the physical constraints imposed by cables and provide greater freedom of movement for both the robot and pool users. However, the absence of a physical communication link presents challenges for transmitting commands and receiving status information from the submerged robot.

Underwater communication presents particular technical challenges due to the properties of water as a transmission medium. Water significantly affects the propagation of various types of signals, including electromagnetic waves, which are commonly used for wireless communication in air. The aquatic environment also introduces background noise from various sources, including pool circulation systems, filtration equipment, and the operational sounds generated by the robots themselves.

Acoustic communication represents one approach for wireless underwater communication, as sound waves can propagate through water more effectively than many other types of signals. However, underwater acoustic communication faces its own set of challenges, including signal attenuation, reflection, interference, and the need to distinguish communication signals from ambient noise in the pool environment.

The pool environment generates various acoustic signals during normal operation, including sounds from motors, pumps, water circulation systems, and human activities. Additionally, the submerged robots themselves produce operational sounds from their motors, brushes, and movement mechanisms. Any communication system must be able to operate effectively in this acoustically complex environment while maintaining reliable signal transmission and reception.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for interacting with a submerged robot is provided. The method comprises receiving by a receiver of a submerged robot, unique signals aimed to the submerged robot. The unique signals are sound signals having frequencies that differ from (a) frequencies of sounds generated by the submerged robot, and (b) frequencies of sounds generated by an environment of the pool. The method further comprises responding, by the submerged robot, to the unique signals.

According to other aspects of the present disclosure, the method may include one or more of the following features. The unique signals may be sound signals having frequencies within a frequency range of 11 Khz to 12 Khz.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a device for communicating with a submerged robot having piezo disks, according to aspects of the present disclosure.

FIG. 2 depicts a device diagram showing multiple views of the communication device of FIG. 1, according to an embodiment.

FIG. 3 illustrates an exploded view of a pool cleaning robot with the piezo disks of FIG. 1, according to aspects of the present disclosure.

FIG. 4 depicts three different operational modes for a disk-type component, according to an embodiment.

FIG. 5 illustrates an internal housing with a receiver having a microphone, according to aspects of the present disclosure.

FIG. 6 depicts an ultrasound frequency response graph showing sensitivity measurements, according to an embodiment.

FIG. 7 illustrates a signal generator circuit providing variable signal attenuation, according to aspects of the present disclosure.

FIG. 8 depicts a graph showing multiple signal waveforms with frequency sweeps, according to an embodiment.

FIG. 9 illustrates a method for operating the submerged robot.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Acoustic communication systems for underwater robotics provide a method for transmitting information to submerged devices operating in aquatic environments. In some cases, these systems may utilize sound waves that propagate through water to convey commands, requests, or other data to robotic platforms. The acoustic signals may be designed to carry specific content that can be interpreted by receiving equipment on the submerged robot. Such communication approaches may address challenges associated with wireless communication in underwater environments where traditional radio frequency signals experience significant attenuation.

Pool cleaning robots and similar submerged platforms may benefit from acoustic communication capabilities that allow users to interact with the devices while the devices remain underwater. In some cases, the acoustic signals may be generated by various types of signal sources positioned above or at the water surface. The signals may propagate through the water medium to reach receivers positioned on or within the submerged robot. The acoustic communication may enable real-time control and monitoring of robotic operations without requiring physical cable connections or the need to retrieve the robot from the water.

Unique acoustic signals may be employed to distinguish communication signals from ambient noise and other sounds present in the pool environment. In some cases, these signals may utilize specific frequency ranges, signal patterns, or acoustic characteristics that differ from sounds generated by the robot's own operation or environmental noise sources. The selection of appropriate acoustic parameters may help ensure reliable signal detection and interpretation by the receiving systems. Various types of acoustic transducers, microphones, and signal processing equipment may be utilized to generate, transmit, receive, and decode the acoustic communication signals.

The acoustic communication approach may support bidirectional information exchange between surface-based control systems and submerged robots. In some cases, the submerged robot may also generate acoustic signals to transmit status information, sensor data, or responses back to surface-based receivers. This bidirectional capability may enable more sophisticated control and monitoring scenarios where the robot can provide feedback about its operational state, environmental conditions, or task completion status. The acoustic communication system may incorporate various signal encoding and decoding techniques to ensure accurate information transfer in the challenging underwater acoustic environment.

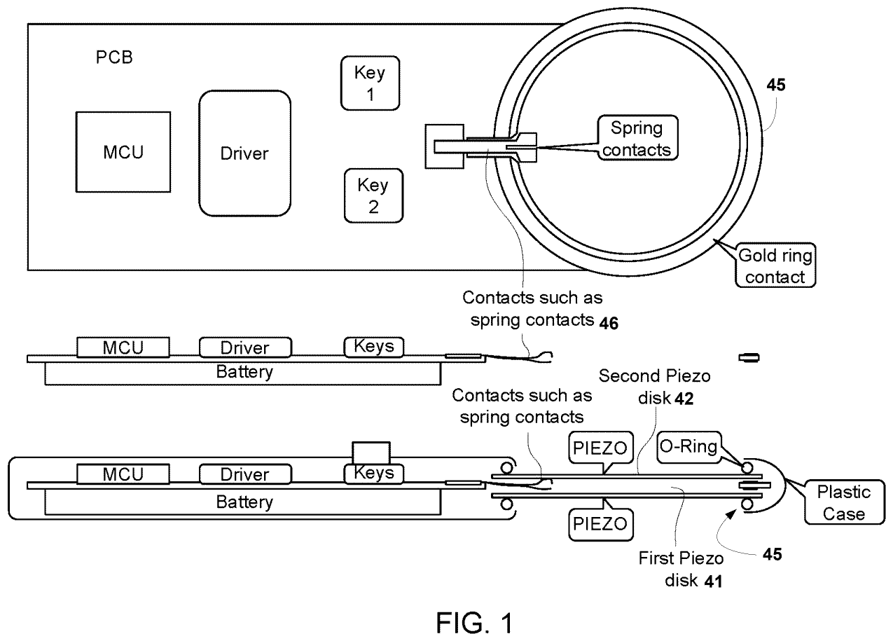

Referring to FIG. 1, a communication device for interacting with submerged robots may include a first piezo disk 41 and a second piezo disk 42 configured to generate ultrasonic signals for underwater transmission. The first piezo disk 41 and second piezo disk 42 may be positioned in a movable configuration where the piezo disks are fed by contacts such as spring contacts that provide electrical connections. In some cases, the first piezo disk 41 and second piezo disk 42 may be movable under the control of electrical signals in relation to each other to provide ultrasonic signals that are directed upwards and downwards. The movable arrangement of the first piezo disk 41 and second piezo disk 42 may enable directional control of the acoustic energy transmission patterns. A minimal gap of about 1-3 millimeters may be maintained between the first piezo disk 41 and second piezo disk 42 to allow for controlled movement while maintaining acoustic coupling between the disk s.

The communication device may incorporate angular control elements positioned above and below the first piezo disk 41 and second piezo disk 42 to manage the propagation characteristics of the ultrasonic waves. In some cases, angular rings may be provided above and below the movable piezo disks to control angular propagation of ultrasonic waves and spread the acoustic signals in multiple directions. The angular control elements may function to direct and shape the acoustic beam patterns generated by the piezo disk assembly. The distance between adjacent angular rings may be configured to be large enough to allow uninterrupted flow of water between the adjacent angular rings while reducing and eliminating formation of air bubbles that could interfere with acoustic transmission. This spacing arrangement may help maintain consistent acoustic coupling between the device and the surrounding water medium.

With continued reference to FIG. 1, the piezo disks may interface with a ring structure 45 that provides mechanical support and electrical connectivity for the disk s. The ring interface may facilitate the controlled movement of the first piezo disk 41 and second piezo disk 42 while maintaining proper electrical connections through the spring contacts 46. In some cases, the electrical signals applied to the piezo disks may control the relative positioning and movement of the disks to generate specific acoustic output patterns. The directional capability provided by the upward and downward signal transmission may enable targeted communication with submerged robots positioned at various depths or orientations within the water column.

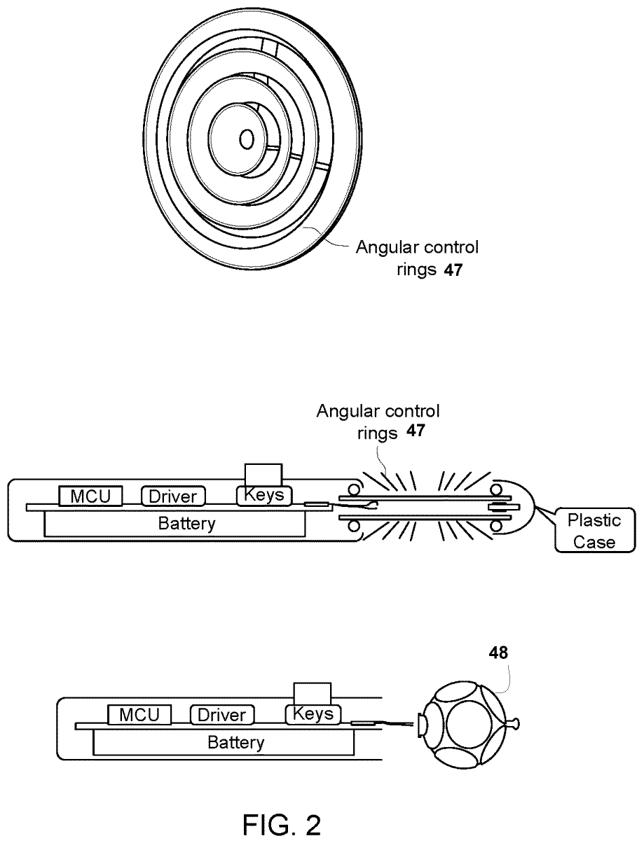

Referring to FIG. 2, a device diagram illustrates alternative configurations for multi-directional acoustic signal transmission. The device diagram shows various arrangements that may incorporate angular control rings 47 in different geometric configurations to achieve omnidirectional or selectively directional acoustic output patterns. In some cases, a ball shaped array of piezo electrical radially symmetrical elements 48 may be used for multi-direction transmission of ultrasonic signals. The radially symmetrical arrangement may provide acoustic coverage in multiple directions simultaneously, enabling communication with submerged robots regardless of their position relative to the communication device. The ball shaped configuration may distribute acoustic energy more uniformly throughout the surrounding water volume compared to directional arrangements.

The angular control rings shown in the device diagram may be arranged in concentric patterns or other geometric configurations to achieve specific acoustic beam shaping characteristics. The ring structures may function as acoustic lenses or waveguides that modify the propagation patterns of the ultrasonic signals generated by the piezo elements. In some cases, the angular rings may be positioned at predetermined spacing intervals to optimize the acoustic coupling and minimize interference effects between adjacent ring elements. The water flow characteristics around the angular rings may be designed to prevent the accumulation of air bubbles or debris that could degrade acoustic transmission performance. The multi-directional transmission capability may enable simultaneous communication with multiple submerged robots or provide redundant signal paths to improve communication reliability in challenging underwater environments.

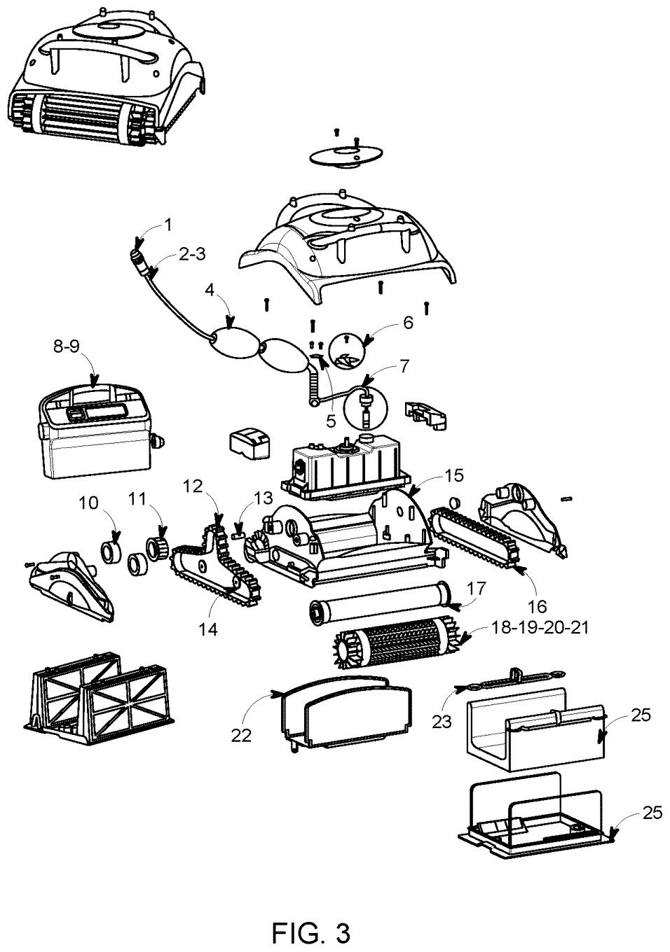

Referring to FIG. 3, an exploded view of a submerged robot that is a pool cleaning robot. FIG. 3 illustrates the integration of communication components within a comprehensive mechanical assembly designed for underwater operation. The robot assembly may include an upper housing 8 and a lower housing 9 that form the primary structural enclosure for the internal components and systems. The upper housing 8 and lower housing 9 may be configured to provide watertight protection for electronic components while allowing for the necessary mechanical interfaces required for robot mobility and cleaning operations. A first side panel 10 and a second side panel 11 may be positioned to provide additional structural support and may serve as mounting surfaces for various subsystems including drive mechanisms and sensor equipment. The side panel configuration may facilitate access to internal components during maintenance operations while maintaining the structural integrity of the robot assembly during underwater operation.

The communication system integration may include a first piezo disk 41 and a second piezo disk 42 that are incorporated into the robot structure to enable acoustic signal reception and transmission capabilities. A third contact may provide electrical connectivity between the piezo disk s and the robot's control electronics. The piezo disk components may be mechanically supported by a mounting spring that provides both structural support and vibration isolation for the acoustic transducer elements. A connection ring may serve to mechanically couple the piezo disk assembly to the robot housing structure while maintaining proper electrical isolation and acoustic coupling characteristics. The mounting spring may be configured to allow controlled movement of the piezo disks in response to acoustic signals while preventing excessive mechanical stress that could damage the transducer components.

The mobility system of the robot may incorporate a first track 12 and a second track 13 that provide traction and steering capabilities for underwater navigation. The track assemblies may be driven by a drive belt 14 that transfers power from internal drive motors to the track mechanisms. A motor mount 15 may provide structural support for the drive motors and may be configured to isolate motor vibrations from the acoustic communication components to prevent interference with signal reception and transmission. The drive belt 14 may be constructed from materials that provide reliable power transmission in the underwater environment while resisting degradation from chemical exposure and mechanical wear. The first track 12 and second track 13 may incorporate tread patterns or surface textures designed to provide effective traction on various pool surface materials including concrete, tile, and liner surfaces.

The cleaning system may include a brush roller 16 that incorporates a brush core 17 as the central structural element supporting multiple brush segments. A first brush segment 18, a second brush segment 19, a third brush segment 20, and a fourth brush segment 21 may be arranged along the brush core 17 to provide comprehensive cleaning coverage as the brush roller 16 rotates during operation. The brush segments may be constructed from materials selected for effective debris removal while avoiding damage to pool surfaces. The brush core 17 may be configured to interface with drive mechanisms that provide rotational power to the brush roller 16 during cleaning operations. The segmented brush design may allow for replacement of individual brush segments as they experience wear, extending the operational life of the cleaning system and reducing maintenance costs.

With continued reference to FIG. 3, the filtration system may incorporate a filter assembly 23 that is supported by a filter frame 22 and enclosed within a filter housing 25. The filter assembly 23 may contain filtration media designed to capture debris and contaminants removed from pool surfaces during cleaning operations. The filter frame 22 may provide structural support for the filtration media and may incorporate sealing surfaces that prevent bypass flow around the filter elements. The filter housing 25 may be configured to direct water flow through the filter assembly 23 while providing protection for the filtration components from mechanical damage during robot operation. The filtration system may be designed to allow for easy removal and cleaning of the filter assembly 23 to maintain optimal cleaning performance throughout extended operational periods.

The integration of the acoustic communication components with the mechanical systems may involve positioning the first piezo disk 44 and second piezo disk 6 in locations that optimize acoustic coupling with the surrounding water while minimizing interference from mechanical vibrations generated by the drive motors and cleaning systems. The connection ring 7 may serve as an interface between the communication components and the robot housing structure, providing mechanical support while maintaining the acoustic isolation necessary for effective signal reception. The mounting spring 5 may be configured with spring characteristics that allow the piezo disks to respond to acoustic signals while filtering out mechanical vibrations from the robot's operational systems. The third contact 3 may provide reliable electrical connections that maintain signal integrity despite the mechanical stresses and environmental conditions encountered during underwater operation.

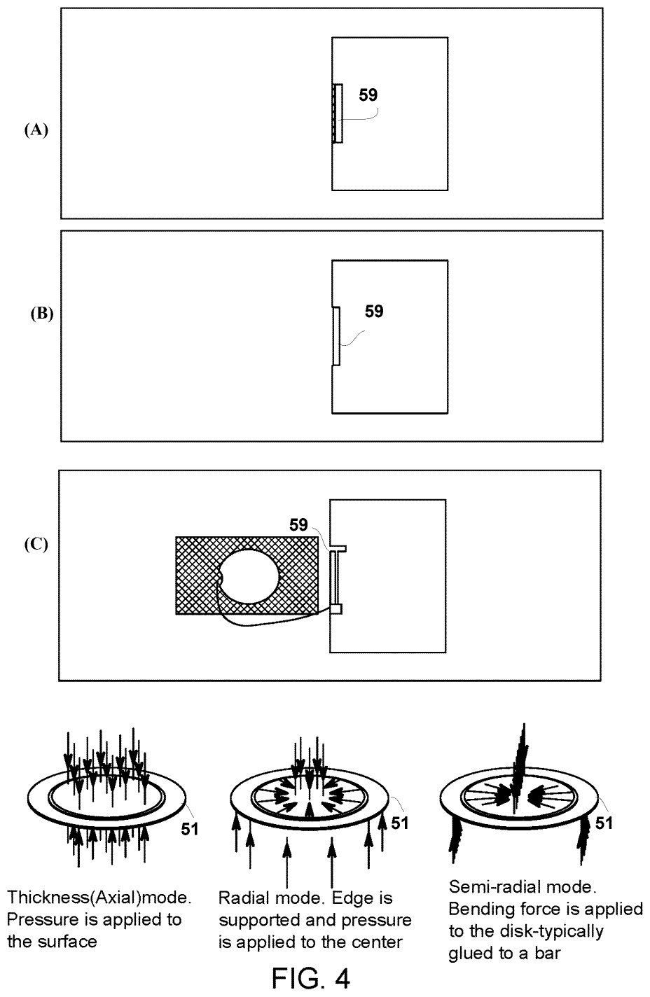

Referring to FIG. 4, piezo disk components may operate in multiple distinct modes that provide different mechanical response characteristics and acoustic output patterns. The operational modes may be selected based on the specific application requirements and the desired acoustic coupling characteristics for underwater communication systems. Each operational mode may involve different force application patterns and corresponding deformation responses that affect the acoustic signal generation and transmission properties of the piezo disk s.

The thickness mode, also referred to as axial mode, may involve the application of pressure forces to the surface of the disk 51 in a direction perpendicular to the disk face. In some cases, the thickness mode operation may cause the disk to expand and contract in the axial direction while experiencing corresponding dimensional changes in the radial direction due to the piezoelectric coupling effects. The force application in thickness mode may be distributed across the entire surface area of the disk, resulting in uniform deformation patterns throughout the disk structure. The acoustic output generated in thickness mode may exhibit specific frequency response characteristics that are determined by the disk thickness, material properties, and boundary conditions. The thickness mode operation may provide effective acoustic coupling for applications where the disk surface is in direct contact with the transmission medium.

The radial mode operation may involve supporting the edge of the disk while applying pressure forces to the center region of the disk structure. In some cases, the radial mode configuration may cause the disk to deform in a radial pattern where the central region moves in one direction while the outer regions experience corresponding movement in the opposite direction. The edge support arrangement may provide a fixed boundary condition that constrains the outer perimeter of the disk while allowing the central region to move freely in response to applied forces. The radial mode deformation pattern may generate acoustic output characteristics that differ from those produced in thickness mode operation. The frequency response and acoustic coupling properties of radial mode operation may be influenced by the disk diameter, material properties, and the specific support configuration used at the disk perimeter.

With continued reference to FIG. 4, the semi-radial mode may provide an alternative operational configuration where one portion of the disk is fixed while another portion remains free and movable about a virtual axis of rotation. In some cases, the semi-radial mode may involve applying a bending force to the disk structure that causes asymmetric deformation patterns across the disk surface. The fixed portion of the disk may be mechanically constrained, such as by being glued to a bar or other support structure, while the free portion may be allowed to move in response to applied forces or electrical signals. The semi-radial configuration may generate acoustic output patterns that combine characteristics of both radial and bending mode operations. The virtual axis of rotation may be positioned at the interface between the fixed and free portions of the disk, allowing the movable section to pivot or flex relative to the constrained section. The semi-radial mode operation may provide enhanced sensitivity for acoustic signal reception applications where the disk functions as a microphone element, as the asymmetric deformation pattern may amplify small acoustic pressure variations in the surrounding medium.

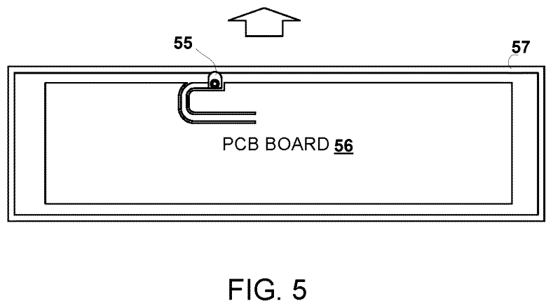

Referring to FIG. 5, the internal housing arrangement may incorporate a receiver configuration that includes a microphone 55 positioned on a printed circuit board (PCB) 56 assembly within the submerged robot structure. The PCB may be configured as a movable portion that allows for precise positioning of the microphone relative to the internal housing components. In some cases, the microphone may be mechanically coupled to the internal housing 57 through direct contact or pressure-based connections that enable the transfer of vibrations from the housing structure to the microphone element. The mechanical coupling arrangement may facilitate the detection of ultrasonic signals that propagate through the water and cause corresponding vibrations in the internal housing structure. The PCB positioning may be adjustable to optimize the contact pressure and alignment between the microphone and the internal housing surfaces.

The microphone may be pressed against a portion of the internal housing that exhibits enhanced responsiveness to ultrasonic signals propagating through the surrounding water medium. In some cases, the selected contact region may be part of a large sidewall area of the internal housing where the structural configuration provides improved acoustic coupling characteristics. The contact portion may alternatively be located in a region of reduced thickness where the housing material provides less acoustic impedance and allows for more efficient transfer of acoustic energy from the water to the internal housing structure. The positioning may also target areas that are more exposed to the water within the submerged robot, where the acoustic coupling between the external water medium and the internal housing may be enhanced. The contact point between the microphone and the internal housing may be configured to provide rigid mechanical coupling without soft or radiation-absorbing materials that could attenuate the acoustic signal transfer.

With continued reference to FIG. 5, the mechanical coupling between the microphone and the internal housing may enable the microphone to sense vibrations that are introduced by ultrasonic signals aimed at the submerged robot. The vibration sensing capability may depend on the acoustic energy transfer from the water medium through the robot housing structure to the microphone element. In some cases, the internal housing may function as an acoustic transmission path that conducts vibrations from the external surfaces in contact with water to the internal surfaces where the microphone maintains mechanical contact. The vibration amplitude and frequency characteristics may be influenced by the housing material properties, thickness variations, and the specific mounting configuration of the microphone assembly. The PCB mounting arrangement may provide controlled pressure application to maintain consistent mechanical coupling while accommodating thermal expansion and mechanical stresses encountered during robot operation.

The microphone component may be selected from various types of acoustic transducers that provide suitable frequency response characteristics for ultrasonic signal detection in underwater applications. In some cases, the microphone may be a MEMS (Micro-Electro-Mechanical Systems) microphone that incorporates miniaturized mechanical and electrical components fabricated using semiconductor manufacturing techniques. The MEMS microphone configuration may provide compact dimensions and reliable performance in the challenging environmental conditions encountered within the submerged robot housing. Alternative microphone types may include other acoustic microphones that are commonly used in dry surroundings, such as the IMP23ABSU microphone, which may be adapted for underwater communication applications through appropriate housing and coupling arrangements. The microphone selection may be based on frequency response characteristics, sensitivity requirements, and environmental compatibility factors that affect performance in the underwater robotic application.

The microphone frequency response characteristics may be configured to operate effectively within specific frequency ranges that correspond to the ultrasonic communication signals used for robot control and monitoring. In some cases, the microphone may be designed to operate within the 20-30 kHz range where ultrasonic communication signals may be transmitted to avoid interference with ambient noise sources in the pool environment. The frequency response may extend beyond the audible range to provide detection capabilities for ultrasonic signals while maintaining sufficient sensitivity for reliable signal reception. The microphone may incorporate internal amplification or signal conditioning circuits that enhance the detection of weak acoustic signals that have propagated through the water medium and the robot housing structure. The acoustic coupling efficiency between the microphone and the internal housing may influence the overall system sensitivity and may be optimized through careful selection of contact materials and pressure application methods.

Referring to the upper side of FIG. 4—for piezo microphone configurations, both sides of the piezo microphone element 59 may be exposed to water (see example (C)) to provide enhanced sensitivity and improved durability compared to configurations (example (B)) where only one side of the piezo microphone is exposed to the water medium-or even when the one side is shieled from the water (example (A)). The dual-side exposure arrangement may allow acoustic pressure variations to act on both surfaces of the piezo element, potentially increasing the mechanical stress and corresponding electrical output generated by the piezoelectric effect. In some cases, the dual-side exposure may provide more balanced acoustic loading that reduces mechanical stress concentrations and extends the operational life of the piezo microphone element. The water exposure on both sides may also provide more uniform temperature distribution across the piezo element, which may improve thermal stability and reduce temperature-induced signal variations. The dual-side configuration may involve sealing arrangements that protect the electrical connections while allowing water contact with the active piezo surfaces.

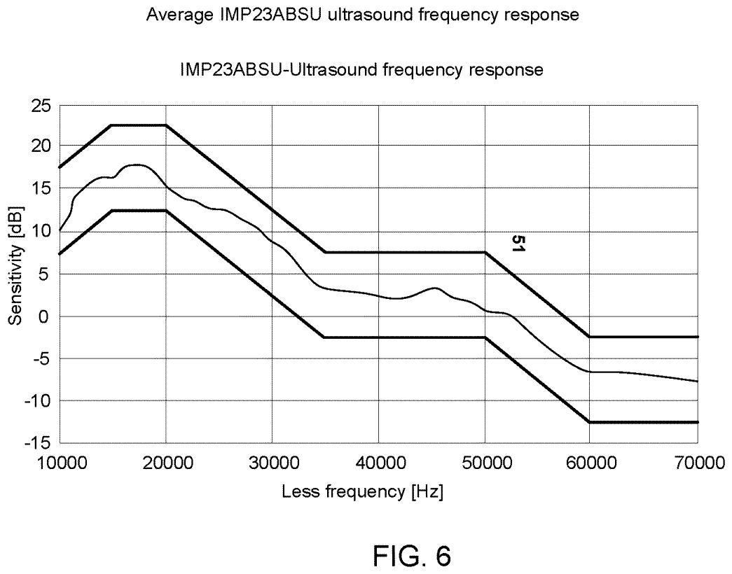

Referring to FIG. 6, the ultrasound frequency response characteristics may demonstrate the sensitivity performance of acoustic communication components across a range of frequencies that extend beyond the audible spectrum. The frequency response graph may show sensitivity measurements plotted against frequency values ranging from approximately 10,000 Hz to 70,000 Hz, with sensitivity values expressed in decibels on the vertical axis. In some cases, the response curve may exhibit multiple peaks and valleys throughout the frequency spectrum, indicating varying levels of acoustic sensitivity at different frequency ranges. The frequency response characteristics may show notable sensitivity variations between 20,000 Hz and 60,000 Hz, where the acoustic transducer elements may provide enhanced or reduced sensitivity depending on the specific frequency values. The response patterns may include three distinct curve variations that represent different measurement conditions or operational modes of the acoustic communication system.

The acoustic communication system may incorporate frequency ranges that extend below 20 kHz, such as frequencies spanning from 3 kHz to 20 kHz, which may allow the use of regular speakers or tweeters that are commonly used in music market applications. In some cases, the frequency range selection may provide compatibility with standard audio equipment that has been developed for consumer audio applications, potentially reducing system costs and improving component availability. The 3 kHz to 20 KHz frequency range may encompass portions of both the audible spectrum and the lower ultrasonic frequency ranges, providing flexibility in signal design and transmission approaches. The frequency response characteristics shown in FIG. 6 may extend well beyond the 20 KHz range to demonstrate the capability of the acoustic transducers to operate in higher ultrasonic frequency ranges where interference from ambient noise sources may be reduced.

With continued reference to FIG. 6, the sensitivity variations across the frequency spectrum may influence the selection of specific frequency ranges for acoustic communication applications in underwater environments. The response curve may show regions of enhanced sensitivity where the acoustic transducer elements provide improved signal detection capabilities, as well as regions of reduced sensitivity where signal transmission or reception may be less effective. In some cases, the frequency response characteristics may be used to identify optimal frequency ranges for specific communication functions, such as command transmission, status reporting, or bidirectional data exchange between surface-based control systems and submerged robots. The multiple peaks in the sensitivity response may correspond to resonant frequencies of the acoustic transducer elements or the mechanical coupling systems that interface the transducers with the surrounding water medium.

The frequency response measurements may provide guidance for signal processing algorithms and communication protocols that optimize the use of available frequency spectrum for underwater acoustic communication. In some cases, the sensitivity variations may be compensated through signal conditioning circuits that apply frequency-dependent amplification or attenuation to achieve more uniform response characteristics across the desired frequency range. The acoustic communication system may incorporate multiple frequency ranges simultaneously to provide redundant communication paths or to enable parallel transmission of different types of information. The frequency response data may also inform the design of acoustic signal generators and receivers to ensure compatibility between transmission and reception components operating in the underwater environment. The extended frequency range capability demonstrated in the response characteristics may enable the acoustic communication system to adapt to varying environmental conditions and interference sources that may affect different portions of the frequency spectrum.

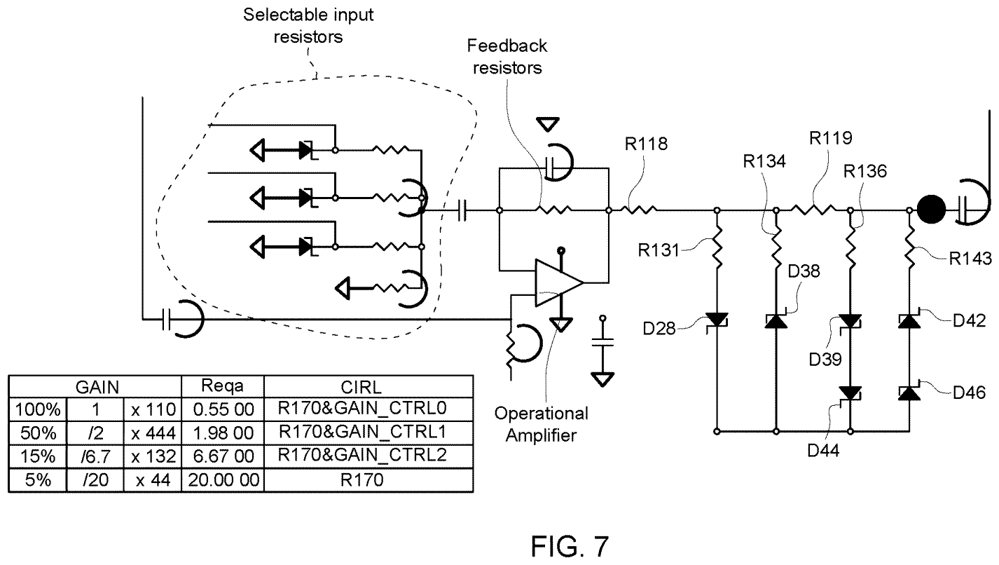

Referring to FIG. 7, a signal generator circuit may incorporate a variable attenuation network that provides progressive signal conditioning based on input amplitude characteristics. The signal generator circuit may include multiple diode elements and resistor networks configured to provide different levels of attenuation based on signal amplitude ranges. In some cases, the circuit configuration may prevent saturation of receiver components by controlling the gain and amplitude of transmitted ultrasonic signals. The variable attenuation approach may address challenges associated with frequency-based interference and signal manipulation effects that occur within pool environments where acoustic signals may experience multiple reflections, destructive and constructive interferences, attenuations, and distortions.

The signal generator circuit may include a reference diode D28 and a threshold diode D38 that establish a first amplitude threshold level for the attenuation network. In some cases, when the amplitude of the input signal remains below twice the forward voltage of the reference diode D28 and threshold diode D38, the signal may pass through a gain resistor R118 and an input resistor R119 without significant attenuation. The gain resistor R118 and input resistor R119 may form an initial signal path that provides minimal signal conditioning for low-amplitude input signals. The forward voltage characteristics of the reference diode D28 and threshold diode D38 may determine the threshold level at which the first stage of attenuation becomes active. The diode configuration may provide a voltage-dependent switching mechanism that activates additional attenuation paths as the input signal amplitude increases beyond predetermined threshold levels.

With continued reference to FIG. 7, the circuit may incorporate a protection diode D39, a clamping diode D42, a signal diode D44, and a limiting diode D46 that establish additional threshold levels for higher amplitude signals. When the amplitude of the input signal reaches a level between twice the forward voltage and four times the forward voltage of the threshold diodes, the reference diode D28 and threshold diode D38 may conduct and introduce additional attenuation through a resistor divider network. In some cases, the resistor divider may include the gain resistor R118, a bias resistor R131, and a voltage divider resistor R134 that provide controlled signal attenuation for intermediate amplitude ranges. The bias resistor R131 and voltage divider resistor R134 may be configured to provide specific attenuation ratios that reduce the signal amplitude while maintaining signal integrity for transmission to the output stage.

The signal generator circuit may provide a third level of attenuation when the input signal amplitude exceeds four times the forward voltage threshold level. In some cases, the protection diode D39, clamping diode D42, signal diode D44, and limiting diode D46 may conduct when higher amplitude thresholds are exceeded, activating additional resistor networks that provide increased attenuation. The higher amplitude attenuation path may include the gain resistor R118, an attenuation resistor R136, and a feedback resistor R143 that form a resistor divider configuration for high-amplitude signal conditioning. The attenuation resistor R136 and feedback resistor R143 may be selected to provide appropriate attenuation levels that prevent output signal saturation while maintaining sufficient signal strength for effective acoustic transmission. The progressive attenuation approach may ensure that the output signal remains within acceptable amplitude ranges regardless of input signal variations.

The signal generator circuit may incorporate multiple input resistor configurations that enable adjustable amplification control for the operational amplifier stage. In some cases, multiple input resistors may be selectively connected to determine the ratio of resistors and therefore control the amplification characteristics of the operational amplifier. The amplification of the operational amplifier may be determined by the ratio between the feedback resistor R143 and the selected input resistor configuration. A control resistor R170 may provide additional control over the operational amplifier characteristics and may be configured to set bias conditions or provide frequency compensation for the amplifier stage. The selectable input resistor approach may enable the signal generator circuit to adapt to different signal source characteristics and transmission requirements encountered in various underwater communication scenarios.

With continued reference to FIG. 7, the variable attenuation network may produce output signals that exhibit non-sinusoidal characteristics due to the clamping effects introduced by the diode networks. The clamping action of the reference diode D28, threshold diode D38, protection diode D39, clamping diode D42, signal diode D44, and limiting diode D46 may modify the waveform shape of the output signal as different amplitude threshold levels are exceeded. In some cases, the non-sinusoidal output characteristics may provide acceptable performance for acoustic communication applications where the receiving systems can accommodate waveform distortions introduced by the amplitude limiting circuits. The clamping effects may help prevent damage to downstream components by limiting peak signal amplitudes while maintaining the fundamental frequency content necessary for effective acoustic signal transmission. The circuit configuration may provide automatic gain control functionality that adapts to varying input signal conditions without requiring active feedback control systems that could introduce complexity and potential stability issues in the underwater communication environment.

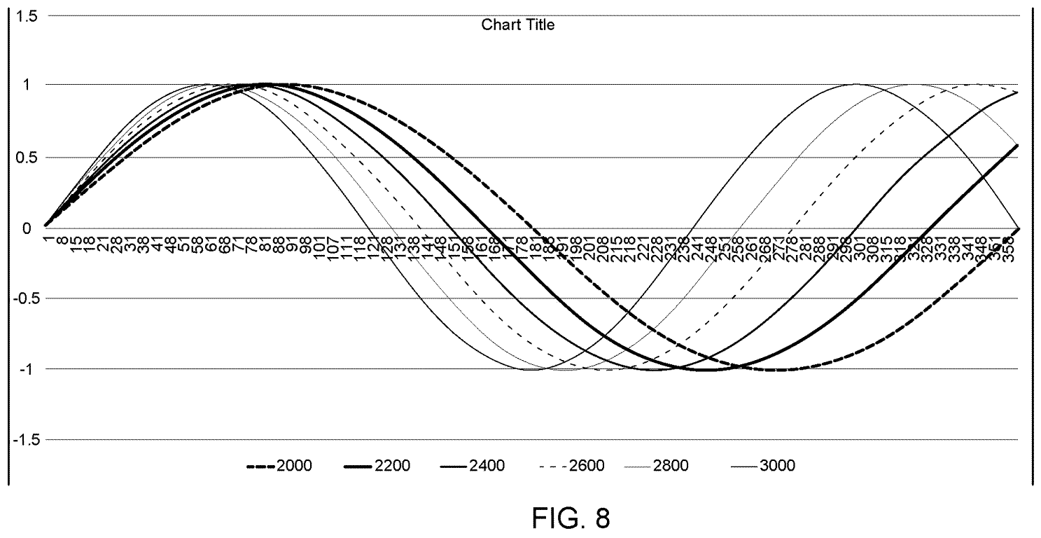

Referring to FIG. 8, frequency sweep signal generation may provide a method for encoding information through controlled variations in acoustic signal frequency over time. The frequency sweep patterns may include at least one of ascending and descending frequency variations that represent different data values or command types for underwater communication applications. In some cases, an ascending frequency sweep may represent a first value while a descending frequency sweep may represent a second value, such as set versus reset conditions or binary data states. The sweep patterns may be generated by systematically varying the frequency of acoustic signals transmitted to submerged robots, providing a robust encoding method that can be distinguished from ambient noise and interference sources in the pool environment. The frequency sweep approach may offer improved signal detection capabilities compared to single-frequency transmission methods, as the sweep patterns may be more readily identified by signal processing algorithms that analyze frequency variations over time.

The timing characteristics of the frequency sweep signals may be configured to provide reliable data transmission while maintaining compatibility with the acoustic propagation characteristics of the underwater environment. In some cases, the duration of a complete frequency sweep may be approximately 200 milliseconds, providing sufficient time for the acoustic signals to propagate through the water medium and be detected by receiving equipment on the submerged robot. Each individual frequency within the sweep pattern may be transmitted for approximately 5 milliseconds, allowing adequate time for signal stabilization and detection while enabling the transmission of multiple frequency components within the overall sweep duration. The 5-millisecond transmission duration for each frequency may provide a balance between signal detection reliability and overall sweep completion time, ensuring that the frequency sweep patterns can be transmitted and received within acceptable time intervals for real-time robot control applications.

With continued reference to FIG. 8, the frequency sweep patterns may exhibit varying amplitudes and frequency characteristics as the signals progress through the ascending or descending frequency ranges. The graph may show multiple signal waveforms plotted over time, with the frequency sweep patterns occurring between approximately 2000 and 3000 milliseconds on the time axis. The signal amplitude variations may range from approximately −1.5 to 1.5 on the vertical scale, indicating the relative strength of the acoustic signals at different points within the sweep patterns. The ascending frequency sweeps may show increasing frequency content over the sweep duration, while descending frequency sweeps may demonstrate decreasing frequency content as the sweep progresses. The differentiation between ascending and descending sweep patterns may enable binary data encoding where each sweep direction corresponds to a specific data value or command instruction for the submerged robot.

The time intervals between successive frequency transmissions within the sweep patterns may be configured to accommodate the acoustic propagation delays and signal processing requirements of the underwater communication system. In some cases, the time difference between transmission of adjacent frequency signals may be fixed or adjustable depending on the specific communication requirements and environmental conditions. The timing intervals may be maintained at consistent values throughout the sweep pattern to provide predictable signal characteristics for receiving equipment, or the intervals may be varied to provide additional encoding capabilities or to adapt to changing acoustic conditions in the pool environment. The frequency sweep generation may be obtained through various methods, including controlled variations in the rotational speeds of motors within the submerged robot, where different motor speeds correspond to different acoustic frequency outputs that combine to form the overall sweep pattern.

The frequency sweep signal patterns may provide enhanced resistance to interference and signal distortion effects that commonly occur in underwater acoustic environments. The sweep approach may enable signal detection even when individual frequency components within the sweep are affected by destructive interference, acoustic reflections, or frequency-selective attenuation caused by the pool structure and water conditions. In some cases, the ascending and descending sweep patterns may be designed to span frequency ranges that avoid known interference sources or ambient noise characteristics typical of pool environments. The signal processing algorithms used to detect and decode the frequency sweep patterns may incorporate frequency domain analysis techniques that can distinguish between the intentional sweep patterns and random frequency variations caused by environmental noise sources. The sweep duration and individual frequency transmission times may be optimized to provide reliable signal detection while minimizing the overall transmission time required for each data element or command instruction sent to the submerged robot.

Piezo element construction may incorporate stainless steel materials that provide enhanced durability and corrosion resistance for underwater acoustic communication applications. Stainless steel piezo elements may offer superior performance characteristics compared to conventional piezo materials when operating in aquatic environments where exposure to water and chemical contaminants may degrade other material types. In some cases, the stainless steel construction may enable direct interface with water without requiring protective barriers that could attenuate acoustic signal transmission or reception. The metallic properties of stainless steel may provide improved mechanical strength and thermal stability compared to ceramic or polymer-based piezo materials, allowing the piezo elements to withstand the mechanical stresses and temperature variations encountered during underwater operation. The stainless steel piezo elements may maintain consistent acoustic coupling characteristics over extended operational periods, even when subjected to continuous water exposure and the chemical environment present in pool water treatment systems.

The water interface capabilities of stainless steel piezo elements may enable direct acoustic coupling between the piezo transducer surfaces and the surrounding water medium. In some cases, the direct water interface may eliminate acoustic impedance mismatches that could occur when protective coatings or barriers are positioned between the piezo element and the water. The stainless steel surface may provide effective acoustic energy transfer from the piezo element to the water during signal transmission operations, as well as efficient transfer of acoustic energy from the water to the piezo element during signal reception. The metallic surface characteristics may facilitate wetting by the water medium, ensuring consistent acoustic contact across the entire active surface area of the piezo element. The stainless steel material may resist the formation of surface deposits or biofilm accumulation that could degrade acoustic coupling performance over time in pool environments where organic and inorganic contaminants may be present.

Sealing techniques for piezo elements may incorporate rubber materials that provide water protection while maintaining acoustic transmission capabilities for ultrasonic wave propagation. The rubber sealing approach may address the challenge of protecting electrical connections and sensitive piezo element regions from water exposure while preserving the acoustic coupling necessary for effective underwater communication. In some cases, the rubber sealing materials may be specifically configured to relay ultrasonic waves in water environments, ensuring that the sealing system does not introduce significant acoustic attenuation or distortion. The rubber material selection may balance the competing requirements of water sealing effectiveness and acoustic transparency, allowing the piezo elements to maintain high sensitivity for both signal transmission and reception operations. The sealing configuration may protect critical electrical interfaces while allowing controlled water exposure to the active acoustic surfaces of the piezo elements.

SHORE 70 rubber may provide optimal characteristics for sealing piezo elements in underwater acoustic applications where ultrasonic wave transmission through the sealing material may be required. The SHORE 70 hardness specification may indicate a rubber material with intermediate stiffness characteristics that provide effective sealing properties while maintaining sufficient acoustic transparency for ultrasonic signal propagation. In some cases, SHORE 70 rubber may offer a balance between mechanical flexibility for sealing applications and acoustic stiffness for efficient ultrasonic wave transmission. The material properties of SHORE 70 rubber may minimize acoustic impedance discontinuities at the interface between the rubber sealing material and the surrounding water medium, reducing signal reflections and transmission losses that could degrade communication performance. The rubber material may maintain consistent acoustic properties across the temperature ranges encountered in pool environments, ensuring reliable sealing and acoustic performance throughout seasonal temperature variations and operational conditions.

The rubber sealing configuration may incorporate design features that optimize both the water protection and acoustic transmission functions of the sealing system. In some cases, the rubber sealing material may be applied in thin layers or specific geometric configurations that minimize the acoustic path length through the rubber while maintaining effective water barrier properties. The sealing design may incorporate multiple sealing interfaces or redundant sealing paths that provide enhanced water protection without significantly increasing the acoustic attenuation introduced by the rubber material. The rubber sealing system may be configured to accommodate thermal expansion and mechanical movement of the piezo elements during operation while maintaining consistent sealing effectiveness and acoustic coupling characteristics. The sealing material may be selected to resist degradation from exposure to pool chemicals, ultraviolet radiation, and temperature cycling that could affect both the sealing performance and acoustic transmission properties over the operational life of the underwater communication system.

Motor-based acoustic signal generation may provide an alternative approach for underwater communication where the submerged robot utilizes existing drive motors and pump motors as acoustic signal sources. The motor-based approach may eliminate the need for dedicated acoustic transducers by leveraging the operational motors that are already present within the robot for propulsion and cleaning functions. In some cases, the motors may be controlled through pulse width modulation (PWM) techniques that enable precise control over the acoustic characteristics of the motor-generated sounds. The PWM control approach may allow the robot to generate specific acoustic patterns while maintaining the motor's primary operational functions for robot mobility and cleaning operations. The dual-purpose utilization of motors for both mechanical drive functions and acoustic communication may provide cost and space advantages compared to systems that incorporate separate acoustic transmission components.

The PWM signal generation may enable control over both the frequency characteristics and pulse width characteristics of the electrical power delivered to the motor coils. Electric power within a motor coil may be determined using pulse width modulation where the PWM signal may be generated at different frequencies to produce corresponding variations in the acoustic noise generated by the motor during operation. In some cases, controlling the frequencies of the PWM signals may result in transmission of acoustic signals that convey desired content to receiving systems positioned within the pool environment or on other robotic platforms. The frequency variations in the PWM signals may cause corresponding changes in the electromagnetic forces within the motor, leading to mechanical vibrations and acoustic emissions that propagate through the motor housing and into the surrounding water medium. The acoustic output characteristics may be influenced by the motor construction, housing materials, and mounting configuration within the robot structure.

The PWM signal characteristics may incorporate variations in pulse width parameters that provide additional encoding capabilities for acoustic communication applications. The PWM signals may be generated with different pulse widths where the pulse width variations may convey information content even when the frequency characteristics remain constant. In some cases, different pulse widths may represent different data values or command types, allowing the motor-based acoustic system to encode information through both frequency and pulse width modulation techniques. Signals with ascending pulse widths may represent a first value while signals with descending pulse widths may represent another value, such as set versus reset conditions or binary data states. The combination of frequency and pulse width variations may provide enhanced encoding capabilities that enable the transmission of more complex information content compared to systems that utilize only frequency variations or only pulse width variations.

The motor speed control approach may involve setting the rotational speed of drive motors or pump motors to multiple discrete speed values that correspond to different acoustic frequency outputs. The speed of rotation of any motor within the submerged robot may be controlled to generate sounds at different frequencies that convey specific content to receiving systems. In some cases, the relationship between motor rotational speed and acoustic frequency output may be determined by the motor construction characteristics, including the number of poles, commutation timing, and mechanical resonances within the motor assembly. The variable speed control may enable the robot to generate acoustic signals across a range of frequencies while the motors continue to perform their primary mechanical functions. The acoustic frequency output may be related to the fundamental motor operating frequency as well as harmonic frequencies generated by the motor commutation process and mechanical interactions within the motor assembly.

The content encoding approach may utilize combinations of frequency and pulse width parameters to represent specific information types or command instructions for underwater communication applications. Different values may be represented by different combinations of frequency and pulse width characteristics, providing a multi-dimensional encoding scheme that enhances the information capacity of the motor-based acoustic system. In some cases, the frequency characteristics may correspond to specific pulse width values where the frequency may be used to validate the pulse width parameters or vice versa, providing error detection capabilities for the acoustic communication system. The validation approach may help ensure accurate information transfer in underwater environments where acoustic signals may be subject to distortion, interference, and attenuation effects. The motor-based acoustic generation may provide acoustic output patterns that differ from the normal operational sounds generated by the motors during standard robot operation, enabling receiving systems to distinguish between communication signals and routine motor noise.

The motor control system may incorporate signal processing capabilities that coordinate the PWM generation with the mechanical requirements of the robot's operational systems. The acoustic signal generation may be synchronized with the robot's movement and cleaning operations to avoid interference between communication functions and primary robot tasks. In some cases, the motor-based acoustic system may operate during periods when the motors are not required for propulsion or cleaning functions, allowing dedicated time intervals for acoustic communication without compromising robot performance. The PWM control algorithms may incorporate timing sequences that alternate between normal motor operation and acoustic signal generation modes, providing both mechanical functionality and communication capabilities within the same motor systems. The acoustic signal patterns may be designed to minimize disruption to the robot's operational efficiency while providing reliable communication capabilities for remote control and status reporting functions.

Frequency domain signal processing techniques may enable the transmission of multiple data words simultaneously through the strategic division of available acoustic spectrum into discrete frequency sub-ranges. The spectrum division approach may allow underwater communication systems to achieve enhanced data transmission rates by utilizing parallel transmission channels that operate concurrently within different portions of the frequency spectrum. In some cases, the frequency range available for acoustic communication may be systematically divided into multiple sub-ranges where each sub-range functions as an independent communication channel capable of transmitting distinct data content. The sub-range division technique may provide a method for increasing the overall information capacity of the acoustic communication system without requiring increases in transmission power or extended transmission time intervals.

The frequency sub-range configuration may involve dividing a broader spectrum, such as the frequency range spanning from 4 kHz to 20 kHz, into seven discrete sub-ranges that enable parallel transmission of seven separate data words. Each sub-range may encompass a specific portion of the overall frequency spectrum, with the sub-range boundaries selected to provide adequate frequency separation between adjacent channels while maximizing the frequency bandwidth available within each sub-range. In some cases, the seven sub-ranges may be configured to allow transmission of seven words in parallel for a defined period such as 0.1 seconds, enabling rapid data transfer rates that exceed the capabilities of sequential single-channel transmission approaches. The parallel transmission capability may provide substantial improvements in communication efficiency for applications where multiple types of information may be transmitted simultaneously to submerged robots or other underwater communication targets.

The data encoding technique within each frequency sub-range may utilize selective frequency transmission where individual frequencies within the sub-range represent specific bit positions within a data word. The transmission of a word may include selectively transmitting frequencies that correspond to set bits within the binary representation of the data word, while frequencies corresponding to reset bits may remain un-transmitted during the communication interval. In some cases, different frequencies within each sub-range may be spaced apart by specific intervals such as 142 Hz, providing adequate frequency separation to enable reliable detection and discrimination between adjacent frequency components. The frequency spacing approach may balance the competing requirements of maximizing the number of available frequency channels within each sub-range while maintaining sufficient frequency separation to prevent interference between adjacent frequency components during transmission and reception operations.

The bit position encoding approach may assign specific frequencies within each sub-range to correspond to individual bit positions within a 16-bit data word structure. The frequency assignment may follow a systematic pattern where the lowest frequency within the sub-range corresponds to the least significant bit position, while progressively higher frequencies correspond to higher-order bit positions within the data word. In some cases, the transmission of a data word such as 0101000000000000 within a sub-range spanning from 4000 Hz to 6130 Hz may involve concurrent transmission of signals at 4142 Hz and 426 Hz, indicating that the second and fourth bits of the data word are set to logic high states. The concurrent transmission approach may enable the entire data word to be transmitted within a single time interval, rather than requiring sequential transmission of individual bit values over extended time periods.

The frequency domain analysis techniques employed by receiving systems may incorporate fast Fourier transform algorithms or other spectral analysis methods to identify the transmitted frequencies within each sub-range and reconstruct the corresponding data words. The receiver may perform frequency domain analysis to detect the presence of specific frequency components within each sub-range and determine which bit positions within each data word are set to logic high states based on the detected frequency content. In some cases, the frequency detection process may involve analyzing the spectral content of the received acoustic signals to identify peaks or energy concentrations at the specific frequencies that correspond to individual bit positions within the data word structure. The spectral analysis approach may provide enhanced noise immunity compared to time-domain signal processing techniques, as the frequency domain analysis may distinguish between intentional communication signals and broadband noise sources that may be present in the underwater acoustic environment.

The parallel transmission capability across multiple sub-ranges may enable simultaneous communication of different types of information or commands to submerged robots operating in complex underwater environments. The seven parallel communication channels provided by the sub-range division technique may support concurrent transmission of robot control commands, status requests, configuration parameters, sensor data, navigation instructions, operational mode settings, and diagnostic information within a single 0.1-second transmission interval. In some cases, the parallel transmission approach may enable more sophisticated communication protocols where multiple aspects of robot operation may be controlled or monitored simultaneously without requiring sequential command transmission that could introduce delays in robot response times. The enhanced communication efficiency provided by the parallel transmission technique may support real-time control applications where rapid response to changing conditions or user inputs may be beneficial for effective robot operation in dynamic pool environments.

Error detection and correction techniques may be incorporated into the frequency domain signal processing approach to enhance the reliability of data transmission in underwater acoustic environments where signal distortion and interference may affect communication performance. The error detection schemes may include cyclic redundancy check algorithms or other error detection methods that enable receiving systems to identify transmission errors and request retransmission of corrupted data words. In some cases, the frequency spacing and sub-range division parameters may be selected to provide inherent error detection capabilities where the presence of unexpected frequency components or the absence of expected frequency components may indicate transmission errors or interference conditions. The error correction capabilities may incorporate redundant encoding techniques where critical information may be transmitted across multiple sub-ranges or multiple frequency components within individual sub-ranges to provide protection against frequency-selective interference or signal attenuation effects that may affect specific portions of the acoustic spectrum.

Speaker configurations for underwater acoustic communication may incorporate specialized construction techniques that provide water resistance while maintaining effective acoustic output characteristics for submerged robot control applications. The speaker design approach may address the challenging requirements of operating in aquatic environments where conventional audio equipment may experience degradation or failure due to water exposure. In some cases, speakers may be built with outer shells that resist water penetration and protect internal components from moisture damage while preserving the acoustic coupling necessary for effective sound transmission into the surrounding water medium. The water-resistant shell construction may involve materials and sealing techniques that prevent water ingress while allowing acoustic energy to propagate from the speaker diaphragm to the external water environment. The shell design may incorporate acoustic windows or membranes that provide water barriers while maintaining acoustic transparency for the frequency ranges used in underwater communication applications.

Alternative speaker mounting approaches may utilize conventional audio speakers that are adapted for underwater applications through mechanical attachment methods that provide water protection and acoustic coupling. Regular speakers may be glued or screwed to robot plastic housing components where the mounting configuration provides both mechanical support and environmental protection for the speaker elements. In some cases, the adhesive bonding approach may create water-tight seals between the speaker housing and the robot plastic surfaces while ensuring effective transfer of acoustic energy from the speaker diaphragm through the robot housing structure to the surrounding water. The bonding materials may be selected to provide long-term adhesion in underwater environments while maintaining acoustic coupling characteristics that preserve the frequency response and output power capabilities of the speaker components. The mechanical attachment approach using screws or other fasteners may provide removable mounting configurations that enable speaker replacement or maintenance while maintaining water-tight sealing through gaskets or other sealing interfaces.

The frequency range capabilities of speakers used in underwater communication applications may encompass portions of the audio spectrum that correspond to conventional music reproduction equipment, enabling the use of commercially available audio components for acoustic signal generation. Speakers designed for music applications may provide frequency response characteristics that span the range from 3 kHz to 20 kHz, encompassing both mid-range and high-frequency audio content that may be suitable for underwater acoustic communication. In some cases, the music frequency range utilization may allow the acoustic communication system to leverage the performance characteristics and cost advantages of mass-produced audio equipment that has been developed for consumer and professional audio applications. The frequency response characteristics of music speakers may provide adequate bandwidth for encoding and transmitting the acoustic signals used for robot control commands, status information, and bidirectional communication between surface-based control systems and submerged robotic platforms.

Tweeter configurations may provide enhanced performance for high-frequency acoustic signal transmission in underwater communication applications where the upper portion of the audio frequency spectrum may be utilized for signal encoding and transmission. Tweeters commonly used for high music frequencies may offer specialized diaphragm materials and acoustic design features that optimize performance in the 3 kHz to 20 KHz frequency range. In some cases, the tweeter design characteristics may provide improved efficiency and frequency response linearity compared to full-range speakers when operating in the frequency ranges most suitable for underwater acoustic communication. The compact dimensions of tweeter assemblies may facilitate integration into submerged robot housings where space constraints may limit the size of acoustic transducer components. The tweeter mounting techniques may involve similar water-resistant construction approaches where the tweeter elements may be sealed within protective housings or bonded to robot plastic surfaces using adhesive or mechanical fastening methods.

Ceramic transceiver technology may provide bidirectional acoustic communication capabilities where a single transducer element functions as both a signal transmitter and a signal receiver for underwater communication applications. A single piezo or ceramic transceiver may transmit and receive acoustic signals through the reversible piezoelectric effect where electrical signals applied to the ceramic element generate mechanical vibrations for signal transmission, while mechanical vibrations induced by incoming acoustic signals generate corresponding electrical outputs for signal reception. In some cases, the bidirectional capability of ceramic transceivers may eliminate the need for separate transmitter and receiver components, reducing system complexity and component count while providing both transmission and reception functions within a single transducer assembly. The ceramic material properties may provide durability and stability in underwater environments where exposure to water and temperature variations may affect transducer performance over extended operational periods.

The piezoelectric characteristics of ceramic transceiver elements may enable efficient conversion between electrical and acoustic energy for both transmission and reception operations in underwater communication systems. The ceramic material may exhibit consistent piezoelectric properties across the frequency ranges used for acoustic communication, providing predictable performance characteristics for signal generation and detection functions. In some cases, the ceramic transceiver may operate across multiple frequency ranges simultaneously, enabling the transmission and reception of different types of acoustic signals within the same transducer assembly. The electrical impedance characteristics of ceramic transceivers may be compatible with standard electronic drive circuits and signal processing equipment, facilitating integration with robot control systems and communication interfaces. The mechanical resonance characteristics of ceramic transceiver elements may be designed to optimize performance within specific frequency ranges that correspond to the acoustic communication protocols used for underwater robot control and monitoring applications.

The mounting and housing configurations for ceramic transceivers may incorporate design features that optimize both the transmission and reception performance while providing environmental protection for the transducer elements. The transceiver mounting approach may position the ceramic element to maximize acoustic coupling with the surrounding water medium while protecting electrical connections and sensitive components from water exposure. In some cases, the housing design may incorporate acoustic coupling interfaces that enhance the transfer of acoustic energy between the ceramic element and the water environment during both transmission and reception operations. The transceiver housing may provide mechanical support and vibration isolation that prevents interference from robot operational vibrations while maintaining sensitivity to acoustic signals propagating through the water medium. The electrical interface design may accommodate the bidirectional signal flow requirements where the same electrical connections may carry both drive signals for transmission operations and sensor signals from reception operations, potentially requiring switching circuits or signal conditioning components that manage the dual-mode operation of the ceramic transceiver assembly.

Acoustic communication methods for underwater robotic systems may provide fundamental approaches for establishing communication links between surface-based control systems and submerged robotic platforms operating in aquatic environments. The communication approach may involve the transmission of unique acoustic signals that carry specific information content to submerged robots equipped with appropriate receiving equipment. In some cases, the acoustic communication method may enable remote control and monitoring of robotic operations without requiring physical cable connections or the need to retrieve the robot from the underwater environment. The method may incorporate signal processing techniques that distinguish communication signals from ambient noise sources and operational sounds generated by the robot systems themselves.

The signal reception process may involve a receiver positioned on or within the submerged robot that detects acoustic signals propagating through the water medium. The receiver may be configured to detect unique signals aimed at the submerged robot where the acoustic signals carry information content intended for robot control or monitoring functions. In some cases, the receiver may incorporate acoustic transducers, microphones, or other sound detection equipment that converts acoustic energy propagating through the water into electrical signals for processing by robot control systems. The receiver configuration may be designed to provide adequate sensitivity for detecting acoustic signals that have propagated through the water medium while maintaining selectivity to distinguish communication signals from background noise sources present in the pool environment.

The unique signal characteristics may be defined by frequency content that differs from sounds generated by the submerged robot during normal operation and from sounds generated by the environment surrounding the pool. The frequency differentiation approach may enable the robot's signal processing systems to identify communication signals among the various acoustic sources present in the underwater environment. In some cases, the unique signals may be sound signals having frequencies that differ from frequencies of sounds generated by the submerged robot, such as motor noise, pump operation sounds, and mechanical vibrations produced by the robot's drive and cleaning systems. The frequency selection may also account for environmental noise sources including pool circulation systems, water movement, human activity, and other ambient sound sources that may be present in the pool area during robot operation.

The frequency range selection for unique signals may encompass portions of the acoustic spectrum that provide optimal signal transmission characteristics while avoiding interference from common noise sources. The unique signals may be sound signals having frequencies within a frequency range of 11 kHz to 12 kHz, providing a narrow frequency band that may be relatively free from interference sources commonly encountered in pool environments. In some cases, the frequencies of the unique signals may exceed ten kilohertz, positioning the communication signals in frequency ranges above most ambient noise sources and robot operational sounds. The frequency range selection between 11 and 12 kilohertz may provide a balance between acoustic propagation characteristics in water and the availability of suitable acoustic transducers and signal processing equipment for both transmission and reception operations.

The acoustic signal generation may be accomplished through various types of signal sources that provide controlled acoustic output characteristics for underwater communication applications. The unique signals may be generated by a device positioned above or at the water surface that incorporates acoustic transducers capable of producing the desired frequency content and signal patterns. In some cases, the unique signals may be generated by a speaker system that converts electrical signals into acoustic energy for transmission through the water medium to the submerged robot. The speaker configuration may incorporate conventional audio equipment adapted for underwater signal transmission or specialized acoustic transducers designed for aquatic communication applications. The signal generation approach may involve electronic signal processing circuits that create the electrical drive signals for the acoustic transducers, enabling precise control over frequency content, signal timing, and acoustic output power levels.

Alternative signal generation approaches may utilize mechanical signal generators that produce acoustic signals through mechanical processes rather than electronic transduction methods. The unique signals may be generated by a mechanical signal generator that creates acoustic energy through controlled mechanical interactions or vibrations that propagate through the water medium. In some cases, the mechanical signal generator may involve impact mechanisms, vibrating elements, or other mechanical systems that produce acoustic signals with the desired frequency characteristics for robot communication. The mechanical approach may provide advantages in terms of simplicity, reliability, and independence from electronic power sources, while still enabling the generation of acoustic signals with sufficient amplitude and frequency content for effective underwater communication.

Human voice signals may provide an alternative approach for generating communication signals where spoken commands or instructions are transmitted to the submerged robot through acoustic propagation in the water medium. The unique signals may be human voice signals that carry verbal commands or information content intended for robot control or monitoring functions. In some cases, the human voice approach may enable direct user interaction with the submerged robot without requiring intermediate electronic devices or signal processing equipment for command generation. The voice signal transmission may involve speaking commands at the water surface where the acoustic energy propagates through the water to reach the robot's receiving equipment. The voice signal approach may incorporate speech recognition capabilities within the robot's signal processing systems to interpret spoken commands and convert the voice content into appropriate control actions or responses.

Partially submerged systems may serve as intermediate communication platforms that facilitate signal transmission between surface-based control systems and fully submerged robots. The unique signals may be generated by a partially submerged system that functions as a communication relay or signal conditioning platform positioned at the water surface interface. In some cases, the partially submerged system may receive commands or information from surface-based sources and convert the received content into appropriate acoustic signals for transmission to the submerged robot. The partially submerged approach may provide advantages in terms of acoustic coupling with both the air and water environments, enabling the system to receive signals from surface-based sources while maintaining effective acoustic transmission capabilities for underwater communication with the submerged robot.

The content encoding capabilities of the acoustic communication system may enable the transmission of various types of information content through the unique acoustic signals. The unique signals may convey content where the acoustic signal characteristics encode specific information intended for interpretation by the submerged robot's control systems. In some cases, the content may include commands that instruct the robot to perform specific actions or operations, such as movement commands, cleaning operation instructions, or operational mode changes. The content may alternatively include requests for information or status reports from the robot, enabling bidirectional communication where the surface-based control system can query the robot for operational data or diagnostic information. The content encoding approach may utilize various signal modulation techniques, frequency patterns, or timing sequences that enable reliable information transfer through the underwater acoustic channel.

The signal processing capabilities within the submerged robot may enable the interpretation and utilization of the content carried by the unique acoustic signals. The method may include determining the content by a processor of the submerged robot where signal processing algorithms analyze the received acoustic signals to extract the encoded information content. In some cases, the processor may incorporate digital signal processing techniques that perform frequency analysis, pattern recognition, or other signal analysis methods to decode the information carried by the acoustic signals. The content determination process may involve comparing received signal characteristics with predetermined signal patterns or frequency templates that correspond to specific commands or information types. The processor may utilize lookup tables, decision algorithms, or other computational methods to translate the decoded signal content into appropriate control actions or responses for the robot systems.

The robot response mechanisms may encompass various types of actions or operations that the submerged robot may perform in response to the received unique signals. The responding by the submerged robot to the unique signals may involve executing commands, providing requested information, or modifying operational parameters based on the content of the received acoustic signals. In some cases, the responding may be based on the content where the specific response actions are determined by the information content decoded from the unique signals. The response selection process may involve the robot's control systems analyzing the decoded content and selecting appropriate actions from a predetermined set of available responses or operational modes.

The movement response capabilities may enable the submerged robot to modify its position or navigation behavior in response to received acoustic commands. The responding may include moving the submerged robot where movement commands transmitted through the unique signals cause the robot to change its position, direction, or navigation pattern within the pool environment. In some cases, the movement response may involve activating drive motors, adjusting steering mechanisms, or modifying propulsion systems to achieve the desired robot motion. The movement commands may specify directional instructions, speed settings, or navigation waypoints that guide the robot to specific locations or along predetermined paths within the pool. The movement response capability may enable remote control of robot positioning for targeted cleaning operations or for positioning the robot for maintenance or retrieval operations.

The surfacing response may provide a mechanism for bringing the submerged robot to the water surface for user interaction, maintenance, or retrieval operations. The responding may include surfacing where acoustic commands cause the robot to cease underwater operations and move to the water surface. In some cases, the surfacing response may involve adjusting buoyancy control systems, activating upward propulsion mechanisms, or modifying operational parameters that cause the robot to rise to the surface. The surfacing capability may be utilized when the robot requires maintenance, battery replacement, or when the user needs to physically interact with the robot for any reason. The surfacing response may incorporate safety features that ensure the robot reaches the surface in a controlled manner without causing damage to pool equipment or creating hazardous conditions.

The stopping response may enable immediate cessation of robot operations in response to emergency commands or when operational suspension may be required. The responding may include stopping the submerged robot where acoustic signals cause the robot to halt all movement and operational activities. In some cases, the stopping response may involve deactivating drive motors, suspending cleaning operations, and placing the robot in a safe operational state while maintaining basic control system functions. The stopping capability may provide a safety mechanism that enables immediate robot shutdown in response to emergency conditions or when robot operations may interfere with pool activities or maintenance procedures. The stopping response may be designed to preserve robot position and operational state information to enable resumption of operations when appropriate restart commands are received.

The positioning response may enable precise robot navigation to specific locations within the pool environment for targeted operations or maintenance procedures. The responding may include reaching a predefined location where the submerged robot navigates to specific coordinates or areas within the pool based on location commands transmitted through the unique signals. In some cases, the positioning response may utilize internal navigation systems, position sensing equipment, or environmental reference points to guide the robot to the specified location. The predefined location capability may enable targeted cleaning operations in specific pool areas, positioning for battery replacement procedures, or navigation to optimal locations for signal reception or transmission operations.

The information transmission response may enable the submerged robot to provide status information, operational data, or diagnostic reports to surface-based control systems. The responding may include generating and transmitting submerged robot content where the robot creates acoustic signals that carry information back to surface-based receivers. In some cases, the submerged robot content may include status reports that provide information about operational parameters, cleaning progress, battery levels, system diagnostics, or environmental conditions detected by robot sensors. The bidirectional communication capability may enable comprehensive monitoring and control of robot operations where both command transmission to the robot and status reporting from the robot are supported through acoustic communication channels.

The battery replacement response may facilitate maintenance operations where the robot participates in procedures for replacing or servicing power supply systems. The responding may include participating in a replacement of a battery of the submerged robot where the robot performs actions that assist in battery maintenance procedures. In some cases, the battery replacement response may involve positioning the robot for easy access, activating maintenance modes that preserve system settings during power interruption, or providing status information about battery condition and replacement requirements. The battery replacement capability may enable extended robot operation through systematic battery maintenance while minimizing disruption to cleaning operations and pool usage.

The ultrasonic signal characteristics may provide enhanced performance for underwater acoustic communication by utilizing frequency ranges above the audible spectrum where interference from human activities and environmental noise sources may be reduced. The unique signals may be ultrasonic signals that operate in frequency ranges typically above 20 kHz where the acoustic propagation characteristics may provide advantages for underwater communication applications. In some cases, the ultrasonic frequency range may offer improved signal-to-noise ratios compared to audible frequency ranges where ambient noise sources may be more prevalent. The ultrasonic approach may enable the use of specialized acoustic transducers and signal processing equipment designed for high-frequency acoustic applications, potentially providing enhanced sensitivity and frequency selectivity for underwater communication systems.

According to an embodiment there is provided a communication device for underwater acoustic transmission, the device includes (a) a ball shaped array of piezo electrical radially symmetrical elements configured for multi-direction transmission of ultrasonic signals; (b) angular control rings arranged in a geometric configuration to achieve acoustic beam shaping characteristics. The radially symmetrical arrangement provides acoustic coverage in multiple directions simultaneously.

According to an embodiment the angular control rings are positioned at predetermined spacing intervals to optimize acoustic coupling and minimize interference effects between adjacent ring elements.

According to an embodiment the ball shaped array enables communication with submerged robots regardless of their position relative to the communication device.

According to an embodiment there is provided a receiver system for a submerged robot, the system includes an internal housing; and a microphone positioned on a printed circuit board assembly within the internal housing. The microphone is mechanically coupled to the internal housing to detect vibrations introduced by ultrasonic signals aimed at the submerged robot.

According to an embodiment the printed circuit board assembly comprises a movable portion that allows for precise positioning of the microphone relative to the internal housing.

According to an embodiment the microphone is pressed against a portion of the internal housing that exhibits enhanced responsiveness to ultrasonic signals propagating through surrounding water.

According to an embodiment the portion of the internal housing comprises at least one of a large sidewall area, a region of reduced thickness, or an area more exposed to water within the submerged robot.

According to an embodiment the microphone comprises a MEMS microphone configured to operate within a frequency range of 20-30 kHz.

According to an embodiment the microphone comprises a piezo microphone element with both sides exposed to water to provide enhanced sensitivity and improved durability.

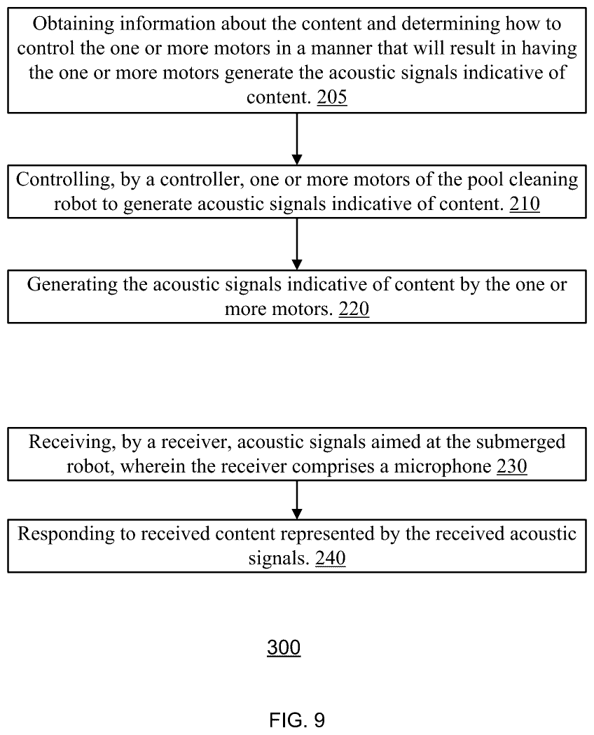

FIG. 9 illustrates an example of method 200 for operating a submerged robot, the method includes step 210 of controlling, by a controller, one or more motors of the pool cleaning robot to generate acoustic signals indicative of content.

The controlling may include setting values of one or more control signals that control one or more motor parameters such as frequency of rotation during one or more time windows of duration that may also be set by the controller.

According to an embodiment step 210 is preceded by step 205 of obtaining information about the content and determining how to control the one or more motors in a manner that will result in having the one or more motors generate the acoustic signals indicative of content. Step 205 may be based on a mapping between values of one or more motor parameters and values of content.

According to an embodiment, step 210 includes controlling at least one of a frequency of the acoustic signals and a pulse width of acoustic pulses generated by the one or more motors.

According to an embodiment, step 210 includes controlling electric power within a motor coil of the at least one of the pump motor and the drive motor using pulse width modulation to generate the acoustic signals.

According to an embodiment, step 210 is followed by step 220 of generating the acoustic signals indicative of content by the one or more motors.

According to an embodiment, step 220 includes generating an ascending sequence of frequencies to represent a first content and/or generating a descending sequence of frequencies to represent a second content that differs from the first content. Any pattern of frequencies and/or pulse widths may be associated with any content.

According to an embodiment, step 220 includes transmitting frequency tones that indicate bits of a first value within the content.

According to an embodiment, the frequency of a pulse generated by the one or more motors may be used to validate a pulse width of the pulse. Thus—if the submerged robot and a receiver share a mapping between frequencies and pulsed widths then assuming that the submerged robot follows the mapping—the receiver may use the mapping to validate the content it receives.

According to an embodiment, the one or more motors include at least one of a pump motor and a drive motor.

According to an embodiment, method 200 includes step 230 of receiving, by a receiver, acoustic signals aimed at the submerged robot, wherein the receiver comprises a microphone.

According to an embodiment, the microphone is positioned on a printed circuit board assembly within an internal housing; wherein the microphone is mechanically coupled to the internal housing to detect vibrations introduced by the acoustic signals aimed at the submerged robot.

According to an embodiment, step 230 is followed by step 240 of responding to received content represented by the received acoustic signals. The responding may include executing one or more commands or instructions included in the received content (for example transmitting status, performing a cleaning operation, exiting the pool, moving, stopping progress, determining whether to execute one or more requests, and the like).

Any reference to “may be” may also refer to “may not be”.

In the foregoing detailed description, numerous specific details are set forth to provide a thorough understanding of the one or more embodiments of the disclosure. However, it will be understood by those skilled in the art that the present one or more embodiments of the disclosure may be practiced without these specific details. In other instances, well-known methods, procedures, and components have not been described in detail so as not to obscure the present one or more embodiments of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present one or more embodiments of the disclosure and in order not to obfuscate or distract from the teachings of the present one or more embodiments of the disclosure.

Any reference in the specification to a method may be applied mutatis mutandis to a system capable of executing the method and may be applied mutatis mutandis to a non-transitory computer readable medium that stores instructions that once executed by a computer result in the execution of the method.

Any reference in the specification to a system and any other component may be applied mutatis mutandis to a method that may be executed by a system and may be applied mutatis mutandis to a non-transitory computer readable medium that stores instructions that may be executed by the system.

Any reference in the specification to a non-transitory computer readable medium may be applied mutatis mutandis to a system capable of executing the instructions stored in the non-transitory computer readable medium and may be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks, circuit elements, or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” may be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather, the scope of the embodiments of the disclosure is defined by the appended claims and equivalents thereof.

1. A submerged robot comprising:
one or more motors; and
a controller configured to control the one or more motors to generate acoustic signals indicative of content.

2. The submerged robot of claim 1, wherein the controller is configured to control at least one of a frequency of the acoustic signals and a pulse width of acoustic pulses generated by the one or more motors.

3. The submerged robot of claim 1, wherein the controller is configured to control the one or more motors to generate at least one of an ascending sequence of frequencies to represent a first content and a descending sequence of frequencies to represent a second content.

4. The submerged robot of claim 2, wherein the controller is to associate between a frequency of a pulse generated by the one or more motors to a pulse width of the pulse.

5. The submerged robot of claim 1, wherein the one or more motors are configured to transmit frequency tones that indicate bits of a first value within the content.

6. The submerged robot of claim 1, wherein the one or more motors comprise at least one of a pump motor and a drive motor.

7. The submerged robot of claim 6, wherein the controller is configured to control electric power within a motor coil of the at least one of the pump motor and the drive motor using pulse width modulation to generate the acoustic signals.

8. The submerged robot according to claim 1, further comprising a receiver for receiving acoustic signals aimed at the submerged robot, wherein the receiver comprises a microphone.

9. The submerged robot according to claim 8, wherein the microphone is positioned on a printed circuit board assembly within an internal housing; wherein the microphone is mechanically coupled to the internal housing to detect vibrations introduced by the acoustic signals aimed at the submerged robot.

10. The submerged robot according to claim 8, wherein the microphone is pressed against a portion of the internal housing.

11. The submerged robot according to claim 8, wherein the microphone comprises a piezo microphone element with both sides exposed to water.

12. A method of operating a submerged robot, the method comprising:
controlling, by a controller, one or more motors of the submerged robot to generate acoustic signals indicative of content.

13. The method of claim 12, wherein controlling the one or more motors comprises controlling at least one of a frequency of the acoustic signals and a pulse width of acoustic pulses generated by the one or more motors.

14. The method according to claim 12, further comprising generating the acoustic signals indicative of content by the one or more motors.

15. The method of claim 14, comprising generating an ascending sequence of frequencies to represent a first content and generating a descending sequence of frequencies to represent a second content.

16. The method of claim 14, comprising transmitting frequency tones that indicate bits of a first value within the content.

17. The method of claim 12, wherein the one or more motors comprise at least one of a pump motor and a drive motor.

18. The method of claim 17, wherein controlling the one or more motors comprises controlling electric power within a motor coil of the at least one of the pump motor and the drive motor using pulse width modulation to generate the acoustic signals.

19. The method according to claim 12, further comprising receiving, by a receiver, acoustic signals aimed at the submerged robot, wherein the receiver comprises a microphone.

20. The method according to claim 19, wherein the microphone is positioned on a printed circuit board assembly within an internal housing; wherein the microphone is mechanically coupled to the internal housing to detect vibrations introduced by the acoustic signals aimed at the submerged robot.
